(19) United States
(12) Patent Application Publication
(10) Pub. No.: US 2026/0219741 A1
(43) Pub. Date: Jul. 30, 2026

(54) PASSIVE INTERACTIVES SYSTEMS

(71) Applicant: Universal City Studios LLC, Orlando, FL (US)

(72) Inventors: Anthony Melo, Orlando, FL (US); Matthew Usi, Glendale, CA (US); Akiva Krauthamer, Orlando, FL (US); Naaima Qadeer, Orlando, FL (US); Nolan O'Keefe, Orlando, FL (US); Eric Boxer, Clermont, FL (US); Karlyn Leander, Orlando, FL (US); Shiyong Chen, Fuzhou (CN); Grace Watts, Ponte Vedra Beach, FL (US)

(21) Appl. No.: 19/398,998

(22) Filed: Nov. 24, 2025

Related U.S. Application Data
(60) Provisional application No. 63/749,152, filed on Jan. 24, 2025.

(51) Int. Cl. G06F 3/03; G06K 7/10; G06K 19/07

(52) U.S. Cl. CPC G06F 3/03; G06K 7/10297; G06K 19/0723

(57) ABSTRACT

An interactive system includes an input device and a base device that, when receiving an input from the input device, outputs an interactive effect. In some embodiments, the input device may include a pressure indicator, such as an aperture or a visual pattern. The base device may include a sensor, such as an air pressure sensor, a camera or image sensor, or a pressure sensor. When the input device is position on the base device and pressure is applied to a body of the input device, the sensor may detect the pressure and/or measure an amount of the pressure, and send an indication to a controller of the base device. The controller may cause an output device to output the interactive effect based on the pressure and/or the amount of the pressure.

### CROSS-REFERENCE TO RELATED APPLICATION

This application claims priority to and the benefit of U.S. Provisional Application No. 63/749,152, entitled “PASSIVE INTERACTIVES SYSTEMS” and filed January 24, 2025, which is incorporated by reference herein in its entirety for all purposes.

### BACKGROUND

The present disclosure relates generally to an interactive system that outputs an interactive effect.

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Traditional interactive experiences, such as those provided in themed entertainment, may be constrained by fixed input devices that cannot be removed or swapped. This lack of mobility restricts the flexibility and adaptability of the interactive elements. Additionally, some interactive experiences may discourage exploration and straying from predetermined paths. These conventional designs may emphasize a singular intended way to interact, limiting the diversity of guest experiences and diminishing the element of surprise. Furthermore, untethered input devices that guests can take home may lack substantial tactile feedback. When tactile feedback is incorporated, it often requires expensive electronic components, making the overall experience cost prohibitive. Moreover, guests may be generally discouraged from removing items from the environment and placing them elsewhere. This restriction hampers the potential for creative and immersive interactions, hindering the full realization of interactive storytelling within the theme park setting.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from embodiments set forth below.

In an embodiment an interactive system includes a passive input device, an output device, and a base device. The base device may receive the passive input device and receive an indication that pressure is applied to the passive input device. The base device may also cause the output device to output an interactive effect based on the indication.

In an embodiment, an input device includes a body having a passive pressure indicator that indicates that pressure is applied to the body. A base device may output an interactive effect based on the pressure when the input device is disposed on the base device.

In an embodiment, a base device includes a sensor that provides an indication that pressure is applied to a passive input device. The base device also includes a controller communicatively coupled to the sensor and an output device. The controller may receive the indication from the sensor and cause the output device to output an interactive effect based on the indication.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective diagram of an interactive system having an input device and a base device, according to an embodiment of the present disclosure;

FIG. 2 is a block diagram of the interactive system of FIG. 1 having the input device and the base device, according to an embodiment of the present disclosure;

FIG. 3A is an input device having a pressure indicator in the form of an aperture or hole, according to embodiments of the present disclosure;

FIG. 3B is an input device having a pressure indicator in the form of a visual pattern, according to embodiments of the present disclosure;

FIG. 3C is an input device having two pressure indicators in the form of apertures, according to embodiments of the present disclosure;

FIG. 3D is an input device having no pressure indicators, according to embodiments of the present disclosure; and

FIG. 4 is a flow diagram of a process for outputting an interactive effect based on pressure applied to the input device of FIG. 1, according to embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to an interactive system that outputs an interactive effect. Traditional interactive experiences in themed entertainment may be constrained by fixed input devices that cannot be removed or swapped. This lack of mobility restricts the flexibility and adaptability of the interactive elements. Additionally, some interactive experiences may discourage exploration and straying from predetermined paths. These conventional designs may emphasize a singular intended way to interact, limiting the diversity of guest experiences and diminishing the element of surprise. Furthermore, untethered input devices that guests can take home may lack substantial tactile feedback. When tactile feedback is incorporated, it often requires expensive electronic components, making the overall experience cost prohibitive. Moreover, guests may be generally discouraged from removing items from the environment and placing them elsewhere. This restriction hampers the potential for creative and immersive interactions, hindering the full realization of interactive storytelling within the theme park setting.

The presently disclosed systems, devices, and methods include an interactive system having a portable, passive input device and a base device that, when receiving an indication that pressure is applied to the input device, outputs an interactive effect. When the input device is placed on the base device and the pressure is applied to the body of the input device, a sensor of the base device may receive an indication of the pressure and/or an amount or intensity of the pressure and send a sensor signal to a processing system of the base device. The processing system may then cause an output device of the base device to output an interactive effect based on receiving the sensor signal.

In an embodiment, the input device may include a pressure indicator, such as an aperture or hole, such that when pressure is applied to the body, the body may expel air from the aperture. In such embodiments, the sensor of the base device may include an air pressure sensor, which may receive the indication that the pressure is applied to the body of the input device in the form of an increase in air pressure due to receiving the air being expelled from the input device. In additional or alternative embodiments, the pressure indicator may include a visual pattern or design, and the sensor of the base device may include a camera or other image sensor. When the pressure is applied to the input device, the visual pattern may change or deform, and the camera may capture a first image of the visual pattern prior to pressure being applied and a second image while pressure is being applied. A controller of the base device may determine the pressure applied to the body and/or an amount of the pressure applied to the body based on the change in the visual pattern as shown in the two images. As another example, the base device may include a pressure sensor, and may receive an indication of the pressure being applied against the body of the input device as transferred to the base device.

Upon receiving the indication of the pressure and/or the amount of the pressure being applied to the body, the processing system of the base device may cause the output device of the base device to output the interactive effect. The interactive effect may include one or more lighting effects, audio effects, imaging effects, video effects, haptic effects, actuating effects, water effects, animatronic effects, movement of objects, and so on. In an embodiment, the interactive effect may change or be different based on the amount of the pressure applied to the body. In additional or alternative embodiments, the processing system may determine a position or portion of the body where the pressure is applied, and the interactive effect may change or be different based on that position or that portion of the body.

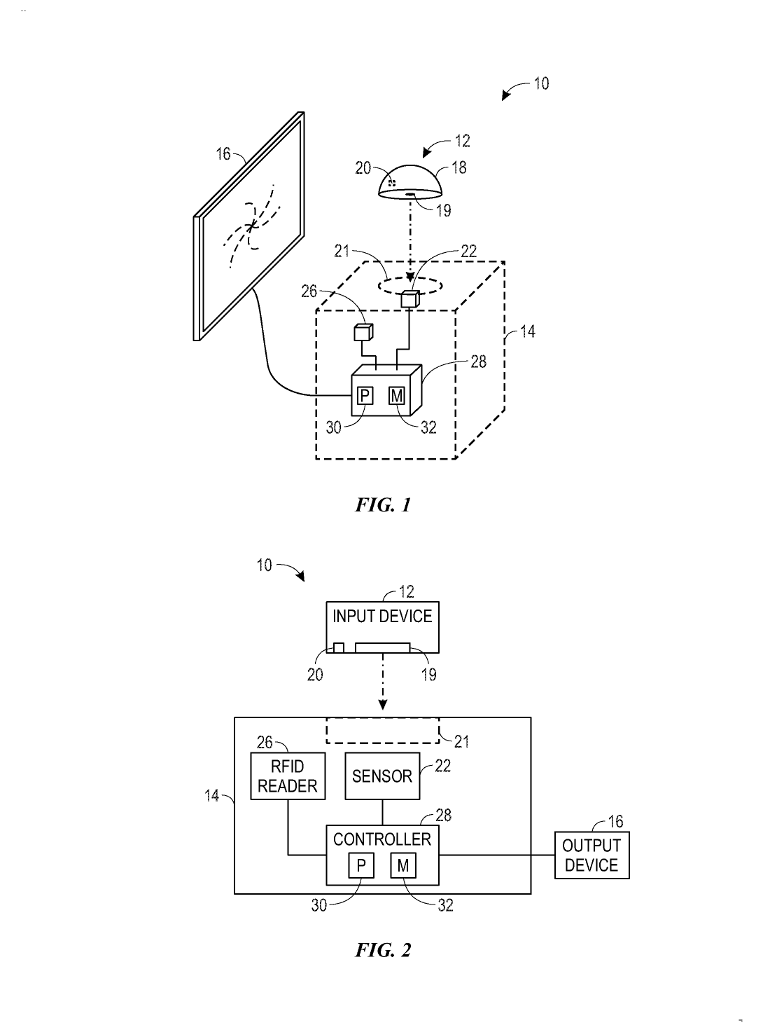

By way of introduction, FIG. 1 is a perspective diagram of an interactive system 10 having an input device 12 and a base device 14, according to an embodiment of the present disclosure. The interactive system 10 may receive an input via the input device 12 and output an interactive effect via an output device 16. As such, in some cases, the interactive system 10 may be used in an entertainment venue, such as a theme park, arcade, restaurant, bar, bowling alley, and so on. Additionally, or alternatively, the interactive system 10 may be used where an interactive effect is desired, such as in a home, grocery store, office setting, commercial setting, industrial setting, or the like.

The input device 12 may be composed of any suitable material that may be deformed under pressure. For example, the input device 12 may be at least partially composed of silicone, rubber, polyurethane, foam, and other similar materials. The material of the input device 12, such as silicone, may facilitate adhering, at least temporarily, the input device 12 to a surface (e.g., the base device 14, a wall, a ceiling). That is, when pressure is applied (e.g., by a user or patron) to the input device 12, a shape of a body 18 of the input device 12 may change (e.g., be depressed, compressed). The body 18 may have any suitable shape, such as a sphere or ball, a dome or half sphere as illustrated, a cube, a rectangular prism, or a triangular prism. In an embodiment, the body 18 may be shaped as an animal or entertainment character, such as a slug, a snail, a jellyfish, an octopus, a fish, a dog, a cat, a human, a cartoon character, or any other popular character.

In an embodiment, the input device 12 may include a pressure indicator 19 (e.g., an indicator that indicates that pressure or an amount or intensity of pressure is being applied to the body 18). For example, the pressure indicator 19 may include an aperture or hole that expels air when the input device 12 is compressed. That is, the input device 12 may include a hollow portion or cavity that couples to the aperture and pressing down on the body 18 of the input device 12 may compress the hollow portion causing air in the cavity to be expelled through the aperture. As another example, the pressure indicator 19 may include a visual pattern or design that is disposed on (e.g., adhered to, etched on, printed on, drawn on) the body 18. As such, applying pressure to the body 18 may cause the visual pattern to deform or change. The visual pattern may include a graphical design, a barcode, a Quick Response (QR) code, and so on. In additional or alternative embodiments, the input device 12 may not include a pressure indicator 19. Accordingly, the pressure indicator 19 may be referred to as an unpowered or passive component, in that it may not receive or require electrical current to operate.

The input device 12 may also include an identifier, such as an electronic communication device (e.g., a radio frequency identification (RFID) tag 20), a barcode, a QR code, an identification number or string, a distinctive color and/or pattern, and so on, that enables identification and/or tracking of the input device 12. In the case of using the RFID tag 20 as the identifier, the RFID tag 20 may include one or more antennas, a radio receiver, and/or a radio transmitter. The RFID tag 20 may be passive, such that it may receive energy, which it may either dissipate, absorb, or store in an electric field or a magnetic field. That is, a passive component may be incapable of controlling current by means of another electrical signal, and may not need any form of independent electrical power to operate. In particular, the RFID tag 20 may receive power from an electromagnetic interrogation pulse emitted by an RFID reader device at the radio receiver, which may activate or turn on the RFID tag 20. Upon receiving the pulse, the RFID tag 20 may transmit digital data, such as an identifier or identifying number, back to the RFID reader via the radio transmitter. In additional or alternative embodiments, the RFID tag 20 may be active and be powered by a power supply. In such cases, the RFID tag 20 may transmit its identifier to be read by the RFID reader. In an embodiment, the RFID tag 20 may be separated or split into two or more portions or pieces, such that the RFID tag 20 may not be activated by the RFID reader. Applying pressure to (e.g., pressing down on or squeezing) the body 18 of the input device 12 may join the two or more portions of the RFID tag 20 together, enabling the RFID reader supply power to and/or activate the RFID tag 20.

The input device 12 may be untethered, separable, and/or removable from the base device 14. That is, guests may physically remove the input device 12 from the base device 14, the interactive system 10, and indeed a theme park having the interactive system 10 to, for example, purchase and/or take the input device 12 home when the guests leave the theme park. Additionally, the input device 12 may integrate with an environment of the interactive system 10 to enable guests to explore and discover the input device 12 organically. The input device 12 may also be passive, such that it does not include any active (e.g., electrically powered) components.

The base device 14 may be of any suitable size or shape that enables the input device 12 to be placed upon the base device 14 and pressure to be applied to the input device 12. In some cases, the base device 14 may be a stand that is at a height convenient for a user or patron to place the input device 12 on the base device 14 and apply pressure. In other cases, the base device 14 may be incorporated or integrated with part of a wall, ceiling, or floor. In such cases, a user may apply pressure to the input device 12 in the direction of the wall (e.g., sideways), the ceiling (e.g., upwards), or the floor (e.g., downwards). The material of the input device 12 may facilitate adhering the base device 14 when the base device 14 is incorporated as the wall or the ceiling. In an embodiment, the base device 14 may take a shape or form to follow a theme of an entertainment attraction, such as a tree trunk when the theme is related to a forest, an animal appendage or body part when the theme is related to an animal, a gasoline pump when the theme is related to a gas station, and so on.

In an embodiment, the base device 14 may include a receiving portion or position 21 at which the input device 12 may be placed. The receiving position 21 may be marked in some manner to facilitate placing the input device 12 in a position such that a sensor 22 may accept an input from the input device 12. For example, the receiving position 21 may be provided as an outline of the input device 12, and a user may intuitively understand that the input device 12 may be placed on the receiving position 21. In an additional embodiment, the receiving position 21 may be indicated by an object or illustration related to a theme of an entertainment attraction. For example, the receiving position 21 may be indicated by a representation (e.g., a three-dimensional or two-dimensional representation) of a fly when the theme of the entertainment attraction is a swamp. The input device 12 in this embodiment may also be related to the theme, and, as such, may be shaped as a frog. A user may understand that the frog-shaped input device 12 may be placed on the fly-shaped receiving position 21 to enable the “frog” to “capture” the “fly,” enabling the sensor 22 to accept an input from the input device 12.

The sensor 22 may include any suitable sensor that may detect when pressure is applied and/or a degree of pressure applied to the input device 12. For example, the sensor 22 may include an air pressure sensor that may detect an increase and/or amount/intensity of air pressure due to receiving air being expelled from the pressure indicator 19 having the form of an aperture of the input device 12 (e.g., when the input device 12 is positioned at the receiving position 21). As another example, the sensor 22 may include a pressure sensor (e.g., a load cell, a force sensor, or the like) that may detect an increase and/or amount of the pressure being applied against the body 18 of the input device 12 (e.g., when the input device 12 is positioned at the receiving position 21). As yet another example, the sensor 22 may include a camera or other image sensor, and the pressure indicator 19 may include a visual pattern. When the pressure is applied to the body 18 of the input device 12, the visual pattern may deform. The camera may capture the images of the visual pattern prior to pressure being applied to the body 18 and while pressure being applied to the body 18 for determining the increase and/or the amount of the pressure being applied against the body 18.

The base device 14 may also include an identifier reader, such as an electronic communication device that may communicate with the electronic communication device of the input device 12 (e.g., an RFID reader 26), a camera or image sensor (e.g., that may be part of the sensor 22), and so on, that may identify the input device 12 based on the identifier of the input device 12. In the case that the identifier reader is the RFID reader 26, the RFID reader 26 may include one or more antennas, a radio receiver, and/or a radio transmitter. The transmitter of the RFID reader 26 may emit an electromagnetic interrogation pulse to be received by a receiver of the RFID tag 20. Upon receiving the pulse, the RFID tag 20 may transmit digital data, such as an identifier or identifying number, to be received and/or read by the receiver of the RFID reader 26. While the disclosed embodiments utilize radio frequency communication to enable the base device 14 to identify the input device 12, it should be understood that any suitable type of communication means may be used (e.g., wired communication or over a communication network using a wireless communication protocol or technology, such as Bluetooth, Wi-Fi, infrared, Ethernet, Thread, ZigBee, Z-Wave, KNX, mobile, and/or microwave).

As illustrated, the base device 14 may include a controller 28, having one or more processors (illustrated as a processing system or processing circuitry 30) and one or more memory or storage devices (illustrated as a single memory device 32). The processing system 30 may execute software programs and/or instructions stored in the memory device 32 that facilitate identifying the input device 12, determining pressure or an amount/intensity of pressure applied to the input device 12, and/or outputting an interactive effect via the output device 16. Moreover, the processing system 30 may include multiple microprocessors, one or more “general-purpose” microprocessors, one or more special-purpose microprocessors, and/or one or more application specific integrated circuits (ASICS). For example, the processing system 30 may include one or more reduced instruction set (RISC) processors. The memory device 32 may store information such as control software, look up tables, configuration data, and so forth. The memory device 32 may include a tangible, non-transitory, machine-readable-medium, such as volatile memory (e.g., a random-access memory (RAM)), nonvolatile memory (e.g., a read-only memory (ROM)), flash memory, one or more hard drives, and/or any other suitable optical, magnetic, or solid-state storage medium. The memory device 32 may store a variety of information and may be used for various purposes, such as instructions that facilitate identifying the input device 12, determining pressure or an amount of pressure applied to the input device 12, and/or outputting an interactive effect via the output device 16.

In an embodiment, the controller 28 may receive an indication that the input device 12 is positioned at the receiving position 21 and output an indication or confirmation that the input device 12 is thus positioned. For example, the controller 28 may include a camera or other image sensor that may capture an image of the input device 12. In an embodiment, the camera or other image sensor may be part of the sensor 22. The controller 28 may determine whether the input device 12 is positioned on the receiving position 21 by performing image recognition and/or analysis on the captured image. If the controller 28 determines that the input device 12 is positioned on the receiving position 21, the controller 28 may cause the output device 16 to output the indication or confirmation that the input device 12 is thus positioned. For example, the controller 28 may cause the output device 16 to output an image, a text, a color, an audio chime, an audio statement, a haptic output, or the like, indicating or confirming that the input device 12 is positioned on the receiving position 21, such that the sensor 22 may measure or determine pressure or an amount/intensity of pressure applied to the body 18 of the input device 12. In an embodiment, the base device 14 may include a lid or top portion that may be opened or activated to enable the input device 12 to be placed on the base device 14. For example, if the base device 14 is shaped as a tree trunk, a lid in the shape of a top of the trunk may be opened, exposing a receiving portion of the base device 14 that includes the receiving position 21, enabling the input device 12 to be placed on the receiving portion at the receiving position 21.

When placed on the receiving position 21, and pressure is applied to the body 18 of the input device 12, such as by pressing down on the body 18, squeezing the body, and so on, the sensor 22 may receive an indication of the pressure and/or an amount of the pressure. For example, the input device 12 may include the pressure indicator 19 in the form of an aperture or hole that expels air when the input device 12 is compressed. The sensor 22, in the form of an air pressure sensor, may detect or measure the air pressure expelled from the aperture, and send an indication of this detection or measurement to the controller 28. As another example, the input device 12 may include the pressure indicator 19 in the form of a visual pattern that is disposed on (e.g., adhered to, etched on, printed on, drawn on) the body 18. As such, applying pressure to the body 18 may cause the visual pattern to deform or change. The sensor 22, in the form of a camera or image sensor, may capture a first image of the visual pattern prior to the pressure being applied, and a second image of the deformed visual pattern while the pressure is being applied, and send the images to the controller 28. The controller 28 may compare the images and determine whether pressure is being applied and/or the amount of pressure being applied to the body 18 of the input device 12 based on changes between the images. In additional or alternative embodiments, the input device 12 may not include a pressure indicator 19. In such cases, the sensor 22 may include a pressure sensor, and the sensor 22 may detect or measure the pressure or the amount of pressure being applied to the body 18 of the input device 12, and send an indication of this detection or measurement to the controller 28. It should be understood that, in some embodiments, the base device 14 may not include the receiving position 21, such as when the sensor 22 may determine the pressure and/or the amount of pressure applied to the body 18 without the input device 12 having to be placed in a specific position on the base device 14.

Because the air pressure expelled through the aperture or the deformation of the visual pattern are caused by the pressure applied to the body 18 of the input device 12, it should be understood that reference in the present disclosure to the pressure applied to the body 18 may also apply to the air pressure expelled through the aperture or the deformation of the visual pattern.

With this in mind, the controller 28 may then cause the output device 16 to output an interactive effect based on the indication. In an embodiment, the controller 28 may cause the output device 16 to output a different interactive effect based on the amount or intensity of pressure applied to the body 18. For example, the controller 28 may cause the output device 16 to output a brighter image the greater the pressure applied to the body 18, output audio at a greater volume the greater the pressure applied to the body 18, output a haptic, actuating, or water effect at greater intensity the greater the pressure applied to the body 18, and so on.

Additionally, or alternatively, the controller 28 may cause the output device 16 to output a different interactive effect based on identifying the input device 12. For example, the memory device 32 may store relationships between identifiers of multiple input devices 12 and different interactive effects. As such, the controller 28 may cause the output device 16 to output a first image, color, sound, and/or effect for a first identifier of a first input device 12, and a second image, color, sound, and/or effect for a second identifier of a second input device 12. Additionally, in some embodiments, multiple input devices 12, multiple base devices 14, and multiple output devices 16 may be used and combined for the controller 28 to cause the output device 16 to output an interactive effect. For example, a first combination of input devices 12 placed on and identified by a first combination of base devices 14, which may receive an indication of pressure applied to the first combination of input devices 12, may cause a first output (or combination of outputs) by a first combination of output devices 16 (e.g., display of a first set of images, color(s), water effect, sound, or other effect). A second combination of input devices 12 placed on and identified by a second combination of base devices 14, which may receive an indication of pressure applied to the second combination of input devices 12, may cause a second output (or combination of outputs) by a second combination of output devices 16 (e.g., display of a second set of images, color(s), water effect, sound, or other effect).

In an embodiment, the input device 12 may include multiple portions, and applying pressure to a first portion may result in a first interactive effect, while applying pressure to a second portion may result in a second, different interactive effect. For example, the input device 12 may include multiple pressure indicators 19 in the form of multiple apertures, each corresponding to and/or located at a respective portion of the input device 12 and/or the body 18 of the input device 12. The base device 14 may include multiple sensors 22 in the form of multiple air pressure sensors, each corresponding to and/or capable of receiving air pressure from a respective pressure indicator 19. Accordingly, a first air pressure sensor 22 may detect or measure air pressure from the first aperture when pressure is applied to the first portion of the input device 12, and a second air pressure sensor 22 may detect or measure air pressure from the second aperture when pressure is applied to the second portion of the input device 12. The controller 28 may thus receive a first indication from the first air pressure sensor 22 when pressure is applied to the first portion of the input device 12 and receive a second indication from the second air pressure sensor 22 when pressure is applied to the second portion of the input device 12. The memory device 32 may store a relationship between a first interactive effect corresponding to the first indication, the first air pressure sensor 22, and/or the first portion of the body 18 of the input device 12, and a second interactive effect corresponding to the second indication, the second air pressure sensor 22, and/or the second portion of the body 18 of the input device 12. The controller 28 may use the relationship to cause the output device 16 to output the first interactive effect based on or when receiving the first indication and/or output the second interactive effect based on or when receiving the second indication.

In an embodiment, the input device 12 may include multiple pressure indicators 19 in the form of multiple visual patterns, each corresponding to and/or located at a respective portion of the input device 12 and/or the body 18 of the input device 12. The base device 14 may include a sensor 22 in the form of a camera, which may capture an image of the visual patterns when pressure is applied to the body 18. For example, the base device 14 may include a pressure sensor that receives an indication that pressure is applied to the base device 14 through the body 18 of the input device, and the controller 28, upon receiving this indication, may cause the sensor 22 to capture the image of the input device 12. The controller 28 may receive the image and determine, using image analysis or recognition techniques, the visual pattern(s) that are deformed or distorted. The controller 28 may then determine that pressure is applied to and/or the amount of pressure applied to the portion(s) corresponding to the deformed visual pattern(s). The memory device 32 may store a relationship between interactive effects corresponding to the portions of the body 18 of the input device 12. The controller 28 may use the relationship to cause the output device 16 to output the interactive effect corresponding to the portion of the body 18 that the pressure is being applied.

In an embodiment, the input device 12 may include no pressure indicator 19, while the base device 14 may include multiple sensors 22 in the form of multiple pressure sensors, or a sensor 22 in the form of a pressure sensor that may detect a source of pressure. The controller 28 may thus receive an indication of where pressure is being applied, and determine a portion of the input device 12 corresponding to where the pressure is being applied. The memory device 32 may store a relationship between interactive effects corresponding to the portions of the body 18 of the input device 12. The controller 28 may use the relationship to cause the output device 16 to output the interactive effect corresponding to the portion of the body 18 that the pressure is being applied. It should be understood that, in some embodiments, different pressure indicators 19 and/or sensors 22 may be combined to determine which portion of the body 18 pressure is applied. For example, the body 18 of the input device 12 may include a first pressure indicator 19 in the form of an aperture, and a second pressure indicator 19 in the form of a visual pattern.

The output device 16 may include any suitable device that outputs an interactive effect (e.g., a visual effect, a lighting effect, an audio effect, an imaging effect, a video effect, a haptic effect, an actuating effect, a water effect, an animatronic effect, a movement of one or more objects, and so on). As such, the output device 16 may include a display (e.g., a liquid crystal display (LCD), a light-emitting diode (LED) display, an organic light-emitting diode (OLED) display, an active-matrix organic light-emitting diode (AMOLED) display, and so on), a projector, a speaker, a motor, an actuator, a water nozzle, a water fountain, and so on.

FIG. 2 is a block diagram of the interactive system 10 of FIG. 1, including the input device 12 and the base device 14. As illustrated, the controller 28 may be communicatively coupled to the sensor 22, the RFID reader 26, and the output device 16. It should be understood that this may be by any suitable means, such as via wired communication or over a communication network using a wireless communication protocol or technology (e.g., radio, Bluetooth, Wi-Fi, infrared, Ethernet, Thread, ZigBee, Z-Wave, KNX, mobile, and/or microwave). Moreover, as discussed above with respect to FIG. 1, the pressure indicator 19 and/or the receiving position 21 are optional. Moreover, the RFID tag 20 may be any suitable type of identifier, including a barcode, a QR code, an identification number or string, a distinctive color and/or pattern, and so on, that enables identification and/or tracking of the input device 12. The RFID reader 26 may be any suitable type of identifier reader, including a camera or image sensor (e.g., that may be part of the sensor 22), that may identify the input device 12 based on the identifier of the input device 12.

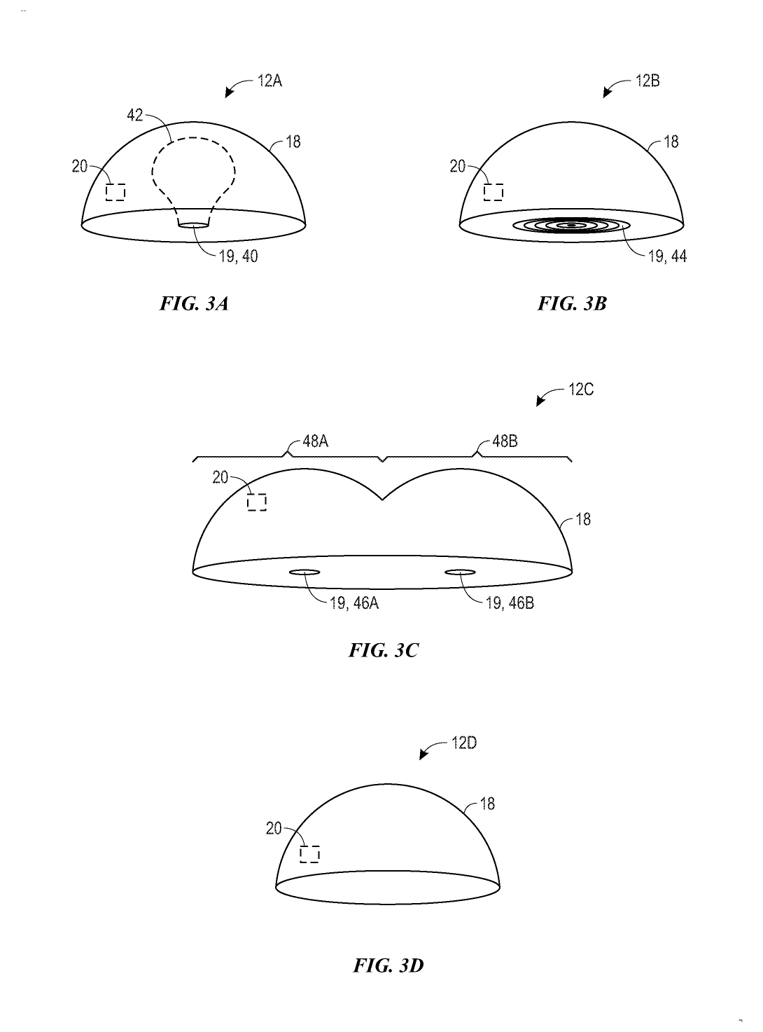

FIGS. 3A-3D are perspective diagrams of embodiments of the input device 12, according to embodiments of the present disclosure. In particular, FIG. 3A is an input device 12A having a pressure indicator 19 in the form of an aperture or hole 40, according to embodiments of the present disclosure. The input device 12A may have a hollow or cavity 42 coupled to the aperture 40. When pressure is applied to the body 18 of the input device 12A (e.g., by pressing down or squeezing the body 18), the cavity 42 may be compressed, causing air to be expelled from the aperture 40. As discussed above, the expelled air pressure may be detected or measured by the sensor 22 of the base device 14 in the form of an air pressure sensor.

FIG. 3B is an input device 12B having a pressure indicator 19 in the form of a visual pattern 44, according to embodiments of the present disclosure. When pressure is applied to the body 18 of the input device 12B (e.g., by pressing down or squeezing the body 18), the visual pattern 44 may change or be deformed. As discussed above, the deformed visual pattern may be captured in an image by the sensor 22 of the base device 14 in the form of a camera or image sensor.

FIG. 3C is an input device 12C having two pressure indicators 19 in the form of apertures 46A, 46B, according to embodiments of the present disclosure. In particular, the input device 12C may have a first portion 48A corresponding to and/or including the first aperture 46A, and a second portion 48B corresponding to and/or including the second aperture 46B. When pressure is applied to the first portion 48A (e.g., by pressing down or squeezing first portion 48A), air may be expelled from the first aperture 46A. When pressure is applied to the second portion 48B (e.g., by pressing down or squeezing second portion 48B), air may be expelled from the second aperture 46B. It should be noted that, in additional or alternative embodiments, other pressure indicators 19, such as visual patterns 44, may be contemplated in place or in addition to the apertures 46A, 46B. Additionally, any number of portions and/or pressure indicators 19 (e.g., three or more, five or more eight or more, ten or more, and so on) are also contemplated. As discussed above, the expelled air pressure may be detected or measured by respective sensors 22 of the base device 14 in the form of air pressure sensors. Moreover, it should be understood that the input device 12 may include any combination of the pressure indicators 19 discussed herein.

FIG. 3D is an input device 12D having no pressure indicators 19, according to embodiments of the present disclosure. As discussed above, pressure applied to the body 18 of the input device 12D may be detected or measured by the sensor 22 of the base device 14 in the form of a pressure sensor (e.g., when the input device 12D is placed on the base device 14).

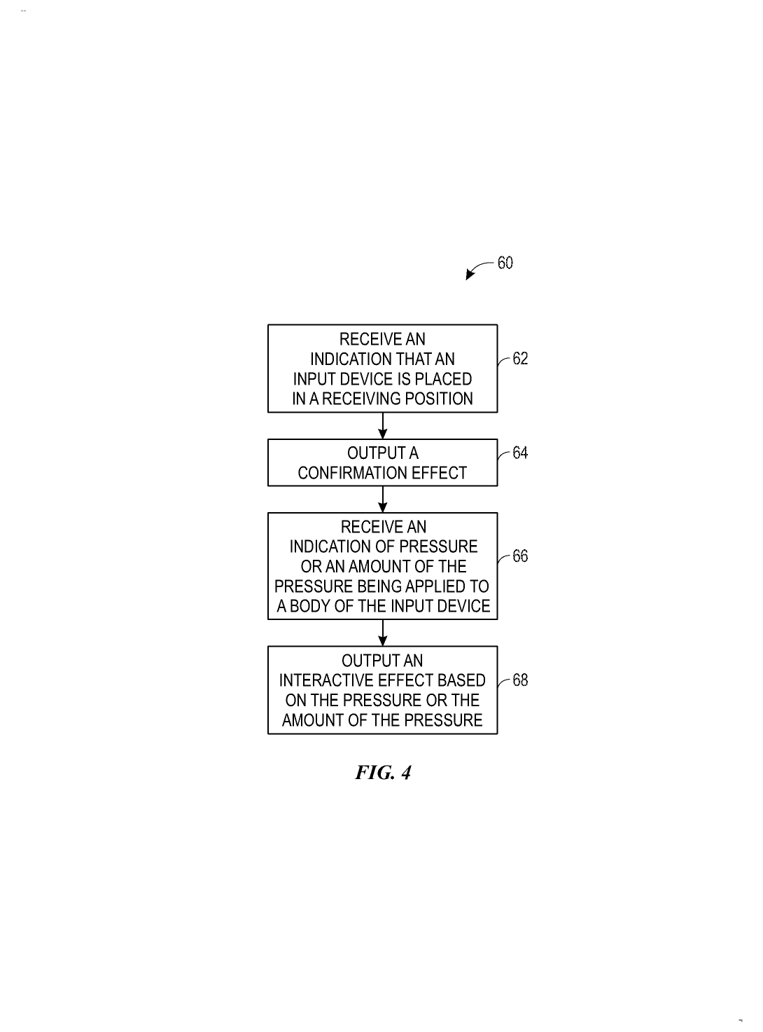

FIG. 4 is a flow diagram of a process 60 for outputting an interactive effect based on pressure applied to the input device 12, according to embodiments of the present disclosure. The process 60 may be performed by any suitable device that may receive an indication that pressure is being applied to the input device 12, such as any component of the base device 14, including the controller 28 and/or the processing system 30. While the process 60 is described using steps in a specific sequence, it should be understood that the present disclosure contemplates that the described steps may be performed in different sequences than the sequence illustrated, and certain described steps may be skipped or not performed altogether. In an embodiment, the process 60 may be implemented by executing instructions stored in a tangible, non-transitory, computer-readable medium, such as the memory device 32, using a processor, such as the processing system 30.

As illustrated, in process block 62, the controller 28 receives an indication that the input device is placed in the receiving position 21. For example, the controller 28 may include a camera or other image sensor (e.g., positioned under the receiving position 21) that may capture an image of the input device 12. In an embodiment, the camera or other image sensor may be part of the sensor 22. The controller 28 may determine whether the input device 12 is positioned on the receiving position 21 by performing image recognition and/or analysis on the captured image.

In process block 64, the controller 28 outputs a confirmation effect that the input device 12 is positioned on the receiving position 21. For example, the controller 28 may cause the output device 16 to output an image, a text, a color, an audio chime, an audio statement, a haptic output, or the like, indicating or confirming that the input device 12 is positioned on the receiving position 21. It should be understood that, in some embodiments, process blocks 62 and 64 may be skipped altogether, as the sensor 22 of the base device 14 may determine the pressure and/or the amount of pressure applied to the body 18 without the input device 12 having to be placed in a specific position on the base device 14.

In process block 66, the controller 28 receives an indication of pressure or an amount of the pressure being applied to the body 18 of the input device 12. For example, if the input device 12 includes a pressure indicator 19 in the form of an aperture 40, and the base device 14 includes a sensor 22 in the form of an air pressure sensor, then the controller 28 may receive the indication from the sensor 22 when air is expelled through the aperture 40. As another example, if the input device 12 includes a pressure indicator 19 in the form of a visual pattern 44, and the base device 14 includes a sensor 22 in the form of a camera or image sensor, then the controller 28 may cause the sensor 22 to capture a first image of the visual pattern 44 when the input device 12 is in the receiving position 21 and capture a second image of the visual pattern 44 when the pressure is being applied. In an embodiment, the sensor 22 may capture multiple images (e.g., being video recording or continuously and/or periodically capture images) of the input device 12 beginning when it detects that the input device 12 is at the receiving position 21. The controller 28 may compare the images to determine whether and/or an amount of pressure is being applied to the input device 12. In yet another example, if the base device 14 includes a sensor 22 in the form of a pressure sensor, then the controller 28 may receive the indication from the sensor 22 when pressure is applied and/or an amount of the pressure being applied.

In process block 68, the controller 28 causes the output device 16 to output an interactive effect based on the pressure or the amount of the pressure. As discussed, the interactive effect may include one or more lighting effects, audio effects, imaging effects, video effects, haptic effects, actuating effects, water effects, animatronic effects, movement of objects, and so on. In an embodiment, the controller 28 may determine whether the pressure or the amount of the pressure is greater than a threshold and cause the output device 16 to output the interactive effect if the pressure or the amount of the pressure exceeds the threshold. Moreover, the controller 28 may cause the output device 16 to output different interactive effects based on the amount of pressure. For example, there may be multiple thresholds associated with different interactive effects (e.g., different volumes of audio output, different brightness of image outputs, and so on). If the amount of pressure is between two thresholds, then the controller 28 may cause the output device 16 to output the interactive effect corresponding to that threshold range. Additionally, or alternatively, each input device 12 may include multiple portions, where each portion is associated with a different interactive effect, such as the input device 12C described in FIG. 3C. As such, the controller 28 may cause the output device 16 to output a different interactive effect corresponding to the portion of the input device 12 that the pressure is being applied. In this manner, the process 60 may output an interactive effect based on pressure applied to the input device 12.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. § 112(f).

1. An interactive system comprising:
a passive input device;
an output device; and
a base device configured to:
receive the passive input device;
receive an indication that pressure is applied to the passive input device; and
cause the output device to output an interactive effect based on the indication.

2. The interactive system of claim 1, wherein the base device comprises a sensor that generates the indication that the pressure is applied to the passive input device.

3. The interactive system of claim 1, wherein the passive input device comprises a radio frequency identification (RFID) tag.

4. The interactive system of claim 3, wherein the base device comprises an RFID reader configured to identify the passive input device based on the RFID tag.

5. The interactive system of claim 4, wherein the base device is configured to output the interactive effect based on the RFID tag.

6. The interactive system of claim 5, wherein the RFID tag is separated into multiple portions.

7. The interactive system of claim 6, wherein the multiple portions are configured to be joined based on the pressure applied to the passive input device.

8. An input device comprising:
a body comprising a passive pressure indicator that is configured to indicate that pressure is applied to the body, and
a base device configured to output an interactive effect based on the passive pressure indicator when the input device is disposed on the base device.

9. The input device of claim 8, wherein the body is configured to adhere to the base device.

10. The input device of claim 8, wherein the passive pressure indicator comprises an aperture.

11. The input device of claim 10, comprising a cavity coupled to the aperture.

12. The input device of claim 11, wherein the cavity is configured to compress when the pressure is applied to the body, causing air in the cavity to expel through the aperture.

13. The input device of claim 8, wherein the passive pressure indicator comprises a visual pattern.

14. The input device of claim 13, wherein the visual pattern is configured to deform when the pressure is applied to the body.

15. A base device comprising:
a sensor configured to provide an indication that pressure is applied to a passive input device; and
a controller communicatively coupled to the sensor and an output device, wherein the controller is configured to:
receive the indication from the sensor; and
cause the output device to output an interactive effect based on the indication.

16. The base device of claim 15, comprising a receiving portion configured to receive the passive input device.

17. The base device of claim 16, wherein the controller is configured to receive an additional indication that the passive input device is positioned on the receiving portion.

18. The base device of claim 17, wherein the controller is configured to cause the output device to output a confirmation effect based on the additional indication.

19. The base device of claim 15, wherein the interactive effect comprises a lighting effect, an audio effect, an imaging effect, a video effect, a haptic effect, an actuating effect, a water effect, or any combination thereof.

20. The base device of claim 15, wherein the sensor comprises an air pressure sensor, a camera, an image sensor, or a pressure sensor.
